(19) United States
(12) Patent Application Publication
(10) Pub. No.: US 2018/0370397 A1
(43) Pub. Date: Dec. 27, 2018

(54) VEHICLE SEAT ARRANGEMENT FOR A MOTOR VEHICLE AND METHOD FOR OPERATING A VEHICLE SEAT ARRANGEMENT

(71) Applicant: Joyson Safety Systems Germany GmbH, Aschaffenburg (DE)

(72) Inventors: Holger RIST, Neu-Ulm (DE); Mirko KORTH, Ulm (DE); Stefan SCHÄFER, Erbach (DE)

(73) Assignee: Joyson Safety Systems Germany GmbH, Aschaffenburg (DE)

(21) Appl. No.: 15/777,661

(22) PCT Filed: Nov. 8, 2016
(86) PCT No.: PCT/EP2016/076923

§ 371 Date: May 19, 2018

(30) Foreign Application Priority Data
Nov. 24, 2015 (DE) 10 2015 223 226.3

(51) Int. Cl. B60N 2/427; B60N 2/02

(52) U.S. Cl. CPC B60N 2/42745; B60N 2/4279; B60N 2/42709; B60N 2/0276

(57) ABSTRACT

A vehicle seat arrangement for a motor vehicle is provided. The vehicle seat arrangement comprises a vehicle seat, a pre-crash control unit which generates a control signal in the case of an impending collision of the motor vehicle, at least one pivoting element which is arranged in or on a backrest of the vehicle seat in order to move a vehicle occupant who is situated on the vehicle seat, and an actuator which, upon a control signal of the pre-crash control unit, which control signal indicates an impending collision, acts on a lever arm of the pivoting element in such a way that the latter performs a pivoting movement which leads to at least one region of the torso of the vehicle occupant being moved away from a possible collision region of the vehicle.

### CROSS-REFERENCE TO A RELATED APPLICATION

This application is a National Phase Patent Application of International Patent Application Number PCT/EP2016/076923, filed on Nov. 8, 2016, which claims priority of German Patent Application Number 10 2015 223 226.3, filed on Nov. 24, 2015.

### BACKGROUND

The invention relates to a vehicle seat arrangement for a motor vehicle. Furthermore, the invention relates to a method for operating a vehicle seat arrangement for a motor vehicle.

Vehicle seats having adjusting elements are known from the prior art, which adjusting elements are used, for example, to set the width of the vehicle seat or, in the case of an impending collision of the vehicle, to give an impulse to a vehicle occupant who is situated on the vehicle seat, which impulse moves said occupant away from the probable collision location. For example, WO 2008/031374 A1 or EP 2 144 787 B1 disclose vehicle seats of this type.

### SUMMARY

The problem on which the invention is based consists in providing a possibility for realizing a vehicle seat arrangement which can be produced in as simple a way as possible and moves a vehicle occupant away from a potential collision location of the vehicle in as reliable a manner as possible.

Said problem is achieved by way of the vehicle seat arrangement having features as described herein and by way of the method having features as described herein.

In accordance with this, a vehicle seat arrangement for a motor vehicle is provided, having
a vehicle seat;
a pre-crash control unit which generates a control signal in the case of an impending collision of the motor vehicle;
at least one pivoting element which is arranged in or on a backrest of the vehicle seat for moving a vehicle occupant who is situated on the vehicle seat; and
an actuator which, upon a control signal of the pre-crash control unit, which control signal indicates an impending collision, acts on a lever arm of the pivoting element in such a way that said pivoting element performs a pivoting movement which leads to at least one region of the torso of the vehicle occupant being moved away from a possible collision region of the vehicle.

The pivoting element therefore acts directly or indirectly on the vehicle occupant, in order to generate a relative movement or a relative velocity between the vehicle occupant and the vehicle seat and/or a vehicle side structure. Said relative movement has the purpose, for example, of moving the vehicle occupant away from a potential collision region of the vehicle and therefore of extending the absorption distance which is available when the collision occurs, and of reducing the loading on the vehicle occupant. In particular, a relative velocity is generated between the vehicle occupant and the vehicle side structure, it being possible for a reduction in the loading to result by way of the relative speed even if the vehicle occupant is not yet situated at a safe distance from the collision location at the time of the collision.

For example, a section of the pivoting element acts via a part of the vehicle seat (for example, via a seat cushion and/or a seat cover, for example of a side bolster of the vehicle seat) on the vehicle occupant who is situated on the seat.

The actuator is, in particular, configured separately from the pivoting element, said actuator being arranged, for example, likewise in or on the backrest of the vehicle seat, however. In particular, the actuator is arranged within a seat cushion of the backrest or at least below a seat cover of the backrest. The pre-crash control unit is, in particular, a control unit of the vehicle and is accordingly situated outside the vehicle seat. Moreover, the actuator can be configured in such a way that it can move the pivoting element abruptly out of a starting position into an activated position. For example, the pivoting of the pivoting element into the activated position takes place within at most one second after the output of the control signal. It is also conceivable that the pivoting element is pivoted out of the activated position back into the starting position again after a predefinable time period (for example, after a few seconds). It is of course also possible that the pivoting element can be moved back into the starting position again by way of a servicing action (for example, a repair shop operation).

In addition, it is conceivable that the pivoting element is configured and arranged in such a way that the pivoting movement leads to at least the region of the torso of the vehicle occupant performing a movement in the vehicle transverse direction. By way of the generation of a movement of this type of the vehicle occupant, in particular, the absorption distance which is present in the case of a side collision of the vehicle can be increased.

In accordance with another development of the invention, the actuator acts on a first lever arm of the pivoting element in such a way that a movement of a second lever arm of the pivoting element is produced, which movement brings about the movement of the vehicle occupant. The pivoting element is mounted, in particular, such that it can be pivoted about an axis which divides the pivoting element into the first and the second lever arm. The first lever arm is situated, in particular, behind the second lever arm (as viewed in the vehicle longitudinal direction), with the result that the actuator can correspondingly likewise be arranged behind the second lever arm and therefore in a rear section of the backrest. This can facilitate the accommodation of the actuator in the backrest.

In particular, the pivoting element is arranged in such a way that, during the performance of the pivoting movement, it acts on a thoracic region and/or shoulder region of the vehicle occupant. The pivoting element is correspondingly situated, for example, at the level of a thoracic and/or shoulder region of the vehicle occupant.

It is possible, in particular, that the pivoting element is arranged at least in sections in or on a lateral region of the vehicle seat (for example, in or on a side bolster of the vehicle seat). It is conceivable, for example, that the pivoting element (as has already been indicated above) is situated at least in sections in a seat cushion or at least below a seat cover. In addition, the pivoting element is arranged, in particular, at least in sections on an inner side (that is to say a side which points away from a vehicle side structure) of a frame of the backrest of the vehicle seat. It is conceivable that a side airbag module is situated on an outer side of the frame.

In accordance with another refinement of the invention, the vehicle seat arrangement comprises two pivoting elements which are arranged at least in sections in or on lateral regions (for example, the abovementioned side bolsters) of the vehicle seat which lie opposite one another, the pivoting elements in each case being assigned an actuator for acting on the pivoting element, and the pre-crash control unit being configured to transmit a control signal only to one of the two actuators in the case of an impending collision of the vehicle. In other words, the one pivoting element is arranged in the one of the two lateral vehicle seat regions, and the other pivoting element is arranged in the other of the two lateral vehicle seat regions. In particular, the pre-crash control unit transmits the control signal to that actuator which is assigned to the pivoting element which is arranged in or on that lateral region of the vehicle seat which lies closest to the probable collision location of the vehicle.

Moreover, it is conceivable that the actuator is configured to exert a pressing force on the pivoting element. For example, the actuator generates a movement of a section of the pivoting element away from the actuator; for example, toward the outside in the vehicle transverse direction, that is to say toward a vehicle longitudinal side. The case is also of course conceivable, however, where the actuator is configured to exert a pulling force on the pivoting element and, for example, to generate a movement of a section of the pivoting element toward the actuator; for example, toward the inside in the vehicle transverse direction, that is to say away from a vehicle longitudinal side.

In accordance with a further exemplary embodiment of the invention, the actuator comprises an inflatable element which is inflated as a reaction to the control signal and acts on the pivoting element. Accordingly, the actuator can have a filling apparatus for filling the inflatable element with gas. The filling apparatus can be situated in the vicinity of the inflatable element, for example likewise in the backrest of the vehicle seat. It is also possible, however, that the filling apparatus is arranged at a different location, for example in or below a seat face of the vehicle seat or else outside the vehicle seat.

Moreover, it is conceivable that the vehicle seat arrangement has a supporting element, on which the inflatable element is supported (in particular, during the inflation). For example, the supporting element is arranged together with the inflatable element in the backrest of the vehicle seat (and, for example, is connected, for instance in one piece, to a frame of the vehicle seat). The supporting element is, for example, a plate (which is configured from a metal or a plastic, for instance) or another rigid element.

It is also conceivable that the actuator comprises an elastic element which acts on the pivoting element as a reaction to the control signal of the pre-crash unit. For example, the elastic element comprises a spring (for example, a helical spring), or it is formed by way of a spring of this type. In particular, in the non-activated state of the actuator, the spring is situated in the stressed state, a (for example, electromagnetic) triggering unit of the actuator releasing the spring upon receiving the control signal of the pre-crash unit, and said spring, during its relaxation, exerting a force on the pivoting element, in particular on a lever arm of the pivoting element. It is conceivable that the spring is configured and arranged as a compression spring or tensile spring.

In accordance with a further variant of the invention, the actuator has a movable element which acts on the pivoting element as a reaction to the control signal of the pre-crash unit. For example, the movable element is a linearly movable element, for example a piston which is arranged such that it can be moved in a linear manner on or in a guide. The movement of the movable element can take place, for example, as a result of the pressure of a released gas. Accordingly, the actuator can have a gas preparation unit (for example, a pyrotechnical unit or a compressed gas reservoir) which is activated upon receiving the control signal of the pre-crash unit.

For example, the pivoting element is configured from metal and/or a plastic. In addition, it is possible that the pivoting element is of plate-shaped configuration at least in sections, that is to say, for example, has at least one section which has a surface with an extent which is greater than its thickness.

Moreover, the pivoting element can be arranged in the backrest of the vehicle seat in such a way that (in relation to the state of the vehicle seat in which it is mounted in the vehicle) it can be pivoted about a rotational axis which runs at least approximately parallel to the vehicle vertical direction.

Accordingly, in the case of a plate-like configuration, the pivoting element can extend along a plane which is oriented parallel to the vehicle vertical direction.

In addition, the pivoting element can also be configured and arranged in such a way that, in the case of a collision of the vehicle, it absorbs energy by way of elastic and/or plastic deformation, that is to say the pivoting element is of elastically or plastically deformable configuration at least in sections. It is of course also possible, however, that the pivoting element is formed at least substantially rigidly.

Moreover, the pivoting element is configured and arranged such that it can be pivoted, in particular, in a reversible manner, that is to say it can be pivoted out of the activated position back into the starting position again. It is also conceivable that the actuator is also of reversible configuration, that is to say can be activated multiple times. This is not necessary, however.

It is also possible that the pivoting element can be used to set the backrest width of the vehicle seat independently of a pre-crash signal for comfort reasons, or that the pivoting element is a part element of a comfort setting means of the vehicle seat. It is also conceivable, however, that the pivoting element supplements a comfort setting mechanism of the vehicle seat, said pivoting element being arranged, for example, above an element of the comfort setting mechanism in the vehicle vertical direction and/or next to or behind an element of the comfort setting mechanism in the vehicle transverse or longitudinal direction. In this case, however, the systems for the pre-crash impulse of the vehicle occupant and the comfort setting means are separate; for example, the comfort setting mechanism has a separate actuator for moving a setting mechanism.

It is of course also conceivable that the pivoting element performs a pure protective function, that is to say is pivoted only upon the signal of the pre-crash unit or upon a signal which signals an actual collision, and the pivoting cannot be triggered by way of the vehicle occupant or by way of a vehicle controller during the normal operation of the vehicle.

The invention also relates to a method for operating a vehicle seat arrangement for a motor vehicle, in particular a vehicle seat arrangement which is configured as described above, having the steps:
providing of a vehicle seat and at least one pivoting element which is arranged in or on a backrest of the vehicle seat; and
generating of a control signal which indicates an impending collision of the motor vehicle,
upon the control signal, a lever arm of the pivoting element being acted on in such a way that said pivoting element performs a pivoting movement which leads to at least one region of the torso of the vehicle occupant being moved away from a possible collision region of the vehicle.

The developments which are described above in relation to the vehicle seat arrangement according to the invention can of course be used analogously with the method according to the invention.

### BRIEF DESCRIPTION OF THE DRAWINGS

The invention will be described in greater detail in the following text using exemplary embodiments with reference to the figures.

FIG. 1 shows a section through a side region of a vehicle seat of a vehicle seat arrangement in accordance with a first exemplary embodiment of the invention.

FIG. 2 shows the vehicle seat from FIG. 1 after activation of the actuator of the vehicle seat arrangement.

FIG. 3 shows a sectional view of a vehicle seat of a vehicle seat arrangement in accordance with a second exemplary embodiment of the invention.

FIG. 4 shows the vehicle seat from FIG. 3 after activation of the actuator.

FIG. 5 shows a sectional view of a vehicle seat of a vehicle seat arrangement in accordance with a third exemplary embodiment of the invention.

FIG. 6 shows the vehicle seat from FIG. 5 after activation of the actuator.

### DETAILED DESCRIPTION

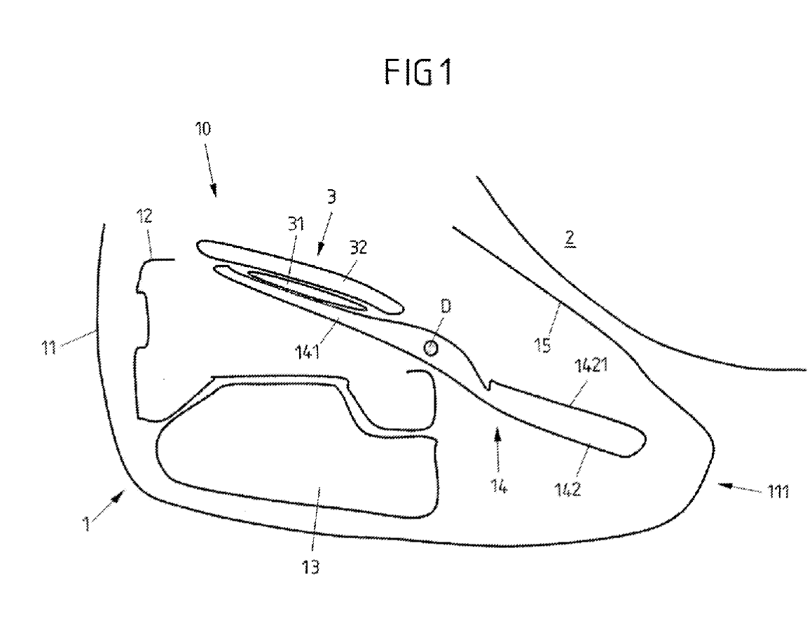

FIG. 1 shows a section through a lateral region of a vehicle seat 1 of a vehicle seat arrangement 10 according to the invention, the section extending through a backrest 11 with a side bolster 111 of the vehicle seat 1. A frame 12 of the vehicle seat 1 extends through the backrest 11, a side airbag module 13 being situated on an outer side of the frame 12.

Furthermore, a pivoting element 14 which is mounted such that it can be pivoted about a pivot point D is arranged in the backrest 11 (for example, at least partially in a cushion of the backrest 11). The pivot point D divides the pivoting element 14 into a first lever arm 141 and a second lever arm 142. The second lever arm 142 extends into the side bolster 111, whereas, as viewed in the vehicle longitudinal direction, the first lever arm 141 is situated in a rear region of the backrest 11 and behind the second lever arm 142. At least the second lever arm 142 of the pivoting element 14 can be of plate-like configuration, with the result that, in particular in the vehicle vertical direction, it has an extent which is greater than its thickness. In addition, the second lever arm 142 has a side 1421 which faces the vehicle occupant 2 and is of substantially planar configuration. It is conceivable that the first lever arm 141 is also configured in the manner of a plate.

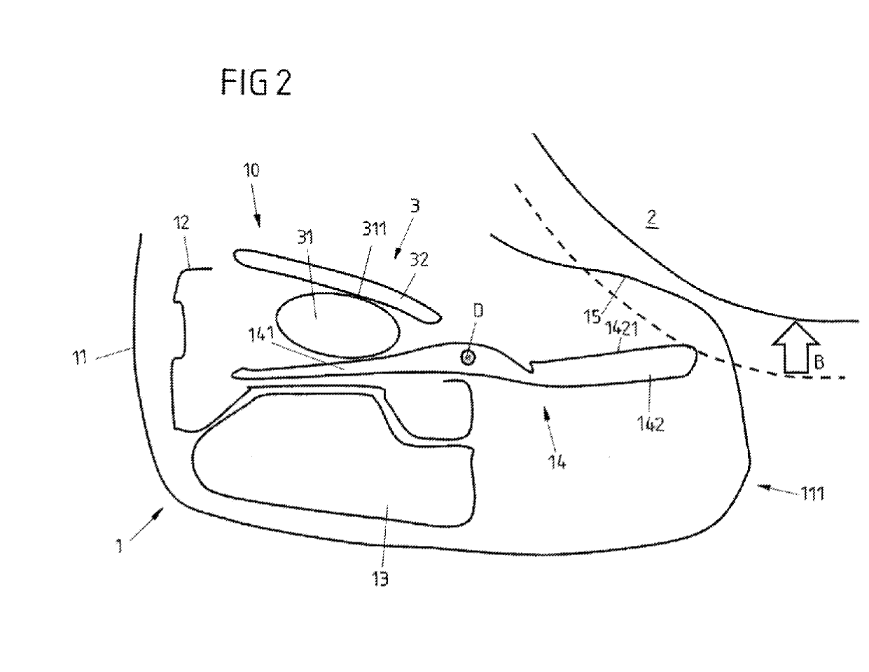

Via a pivoting movement of the pivoting element 14 out of the starting position which is shown in FIG. 1 into an activated position (FIG. 2), it is possible to give an impulse (lateral jolt) to a vehicle occupant 2 who is situated on the vehicle seat 1, which impulse moves said vehicle occupant 2 (at least the torso thereof) away out of his/her seating position in the case of an impending collision of the vehicle. The impulse on the vehicle occupant 2 is generated by virtue of the fact that the first lever arm 141 is moved to the outside, that is to say toward a vehicle side (in the direction of the frame 12), and the second lever arm 142 is therefore pivoted to the inside, that is to say away from the vehicle side (toward a rest face 15 of the backrest 11). As a result of said movement of the second lever arm 142, the side bolster 111 is deformed toward the vehicle occupant 2 until it finally presses against said vehicle occupant 2 and moves at least the torso of the vehicle occupant 2; for example, it results in a tilting movement of the torso.

The pivoting element 14 is set in the pivoting movement via an actuator 3. The actuator 3 comprises an inflatable element 31 and a supporting element 32, the inflatable element 31 being arranged at least in sections between the first lever arm 141 and the supporting element 32. The supporting element 32 is, for example, a plate-shaped element which is as rigid as possible and, for example, is connected fixedly to the backrest 11 (for example, to the frame 12). It is also conceivable that the frame 12 configures the supporting element 32 (in particular in one piece).

The inflatable element 31 is configured, in particular, from an expandable (for example, elastic) shell which encloses an inner volume which can be filled with gas. In order to fill the inflatable element 31, the actuator comprises a filling apparatus (which is not shown in FIG. 1). The filling apparatus can likewise be arranged in the backrest 11 or at another location of the vehicle seat 1. It is also conceivable, however, that the filling apparatus, as has already been mentioned above, is a unit which is external with respect to the vehicle seat.

The actuator 3 is configured to receive a control signal of a pre-crash control unit of the motor vehicle, which control signal signals an impending collision of the vehicle. As a reaction to receiving a control signal of this type, the actuator 3 (in particular, a receiving unit of the actuator) activates the filling apparatus, whereupon the inflatable element 31 is filled with gas (in particular, abruptly).

FIG. 2 shows the state of the actuator 3 and the pivoting element 14 after activation of the actuator 3. The inflated (or at least partially inflated) inflatable element 31 is supported with one side 311 on the supporting element 32, whereas it presses with another section against an inwardly directed (away from the vehicle side) side of the first lever arm 141 and therefore presses the first lever arm 141 outward (as viewed in the vehicle transverse direction), that is to say the pivoting element 14 is pivoted out of the starting position which is shown in FIG. 1 into the activated position.

As a result of the pivoting outward of the first lever arm 141, the second lever arm 142 correspondingly pivots inward, which leads to the deformation (shown in FIG. 2) of the side bolster 111 of the backrest 11. As a result of said deformation of the side bolster 111, the abovementioned impulse is exerted on the vehicle occupant 2, which impulse moves said vehicle occupant (at least his/her torso) out of the normal seating position (dashed line) into a protective position (continuous line) (along the movement direction B which is labeled by way of an arrow and runs at least approximately along the vehicle transverse direction).

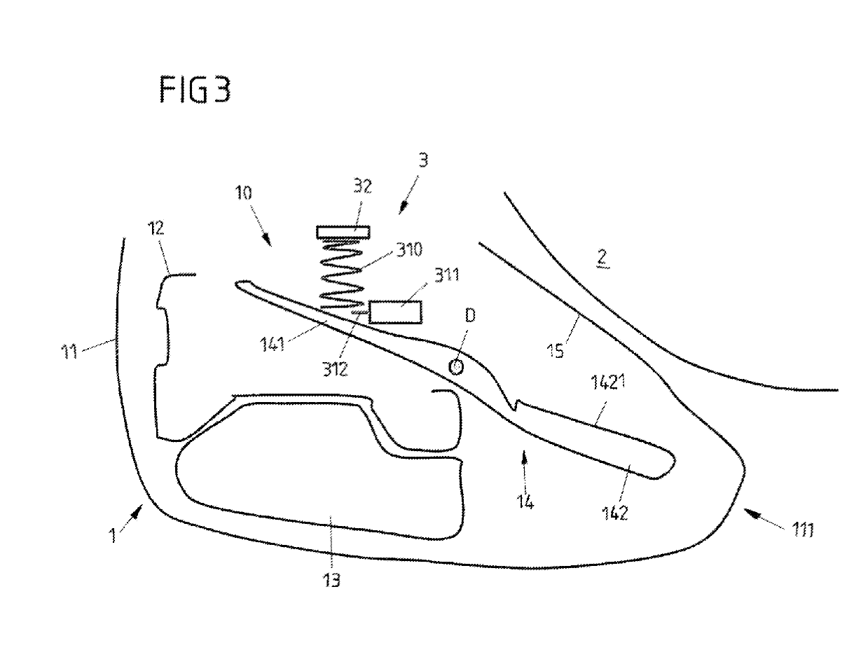

FIG. 3 shows a sectional view (analogous with respect to FIGS. 1 and 2) of a vehicle seat 1 of a vehicle seat arrangement 10 in accordance with another exemplary embodiment of the invention. Here, the actuator 3 does not have an inflatable element, but rather an elastic element in the form of a helical spring 310 which is configured as a compression spring. The spring 310 is mounted on a supporting element 32 and is held in a compressed state by a triggering unit 311 before the activation of the actuator 3. For example, the triggering unit 311 has a locking element 312 which first of all blocks an expansion of the spring 310 to the outside (that is to say, toward the pivoting element 14). The triggering unit 311 is, in particular, an electromagnetic unit which is configured, for example, in the manner of a headrest anti-whiplash triggering means.

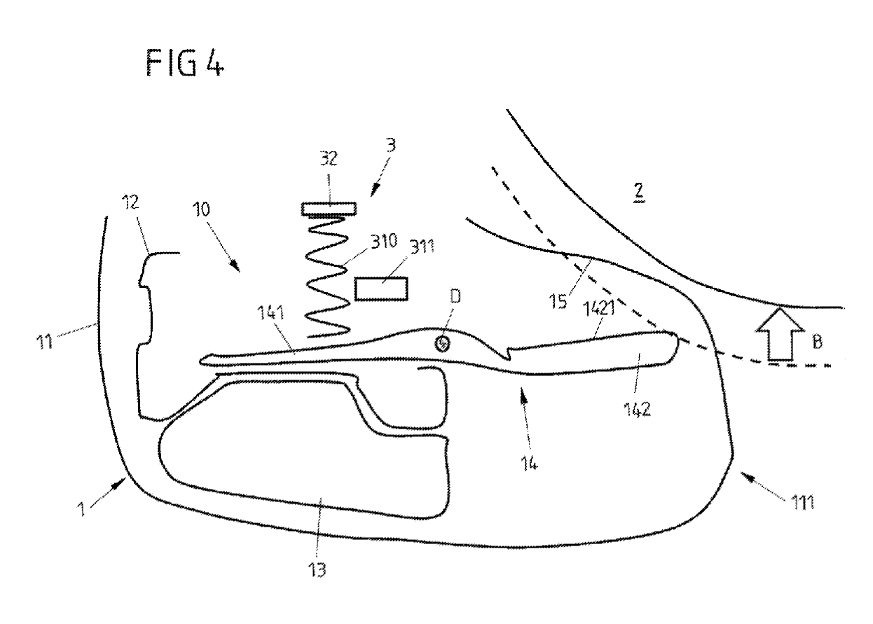

After a control signal of the pre-crash unit of the vehicle is received, the triggering unit 311 cancels the locking action of the spring 310 (for example, by the locking element 312 being moved away from the spring 310), with the result that the spring 310 expands elastically in the direction of the pivoting element 14 (that is to say, in the vehicle transverse direction) and acts on the first lever arm 141 of the pivoting element 14 in such a way that it moves outward and the second lever arm 142 accordingly moves inward. Therefore, the pivoting movement (which has already been explained in relation to FIGS. 1 and 2) of the pivoting element 14 is likewise produced, which pivoting movement moves the vehicle occupant 2 in the vehicle transverse direction toward the inside and therefore away from a potential lateral collision location of the vehicle via a deformation of the side bolster 111 of the backrest 11 (FIG. 4).

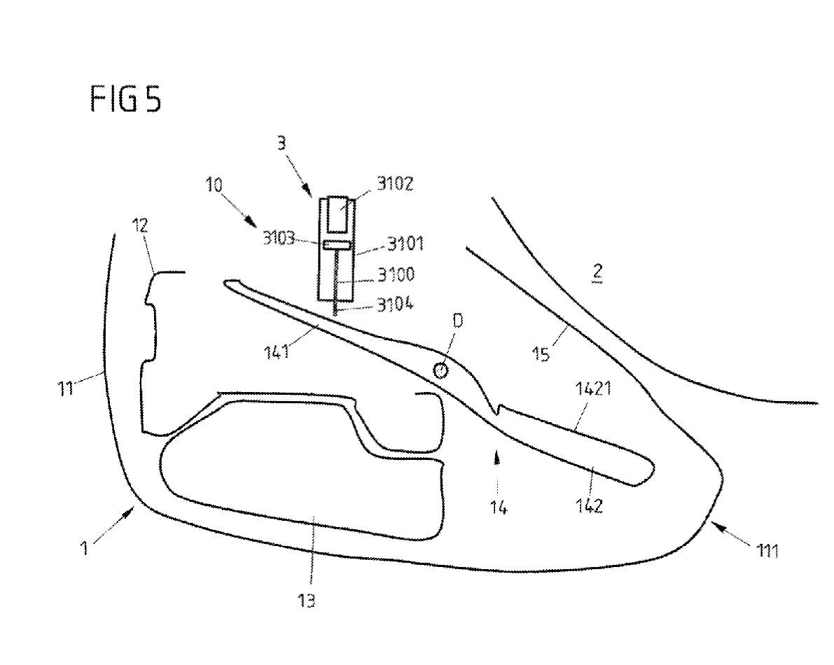

FIGS. 5 (starting state of the pivoting element) and 6 (activated state of the pivoting element) show a further alternative refinement of the actuator 3. In accordance with said figures, the actuator 3 comprises a linearly movable element in the form of a piston 3100 which can be moved along a guide 3101. The guide 3101 is arranged, in particular, in such a way that the piston 3100 can be moved at least approximately in the vehicle transverse direction toward the first lever arm 141 of the pivoting element 14. The guide 3101 is, for example, a hollow cylinder, in which the piston 3100 is arranged.

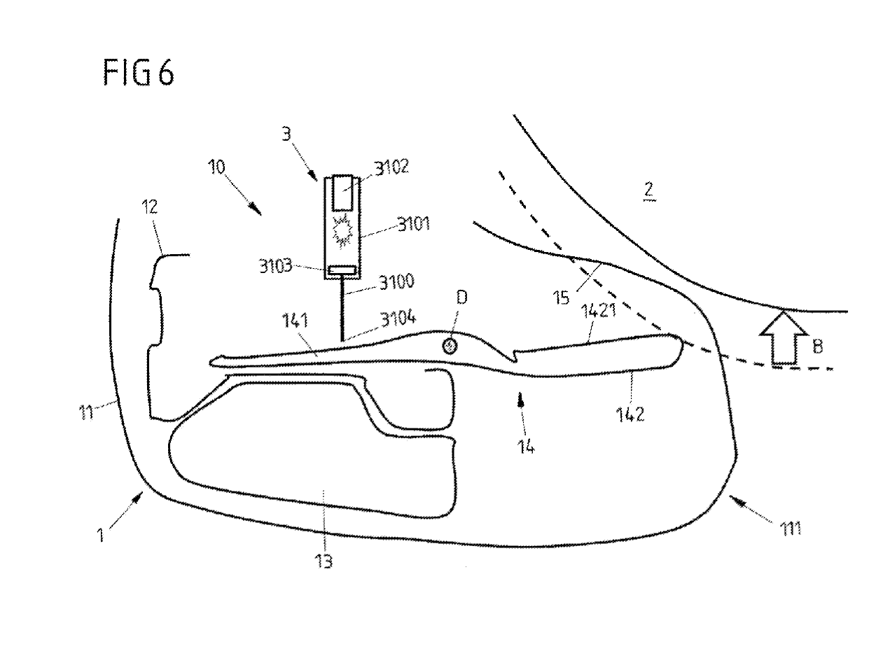

Furthermore, the actuator 3 has an apparatus, via which the piston 3100 can be set in motion. In the present case, said apparatus is a gas provision unit in the form of a pyrotechnical unit 3102 which, after the control signal of the pre-crash unit of the vehicle is received, releases gas in a pyrotechnical way. The released gas acts on a widened end 3103 of the piston 3100 and therefore presses the piston 3100 to the outside toward the first lever arm 141 of the pivoting element 4 (cf. FIG. 6). As a result of the action of the piston 3100, the first lever arm 141, that is to say its end 3104 which faces the pivoting element 14, moves to the outside. Accordingly, the second lever arm 142 is in turn pressed inward, which leads to the movement of at least the torso of the vehicle occupant 2 toward the vehicle center. The actuator of FIGS. 5 and 6 can be configured, for example, in the manner of a belt tensioner actuator.

It is noted that the design variants of the actuator 3 which are shown in FIGS. 1 to 6 might also be used in combination with one another. Thus, different mechanisms for pivoting the pivoting element can certainly be used together; for example, a combination of a spring element with an inflatable element. Furthermore, it is noted that of course the two lateral regions of the vehicle seat can have the arrangements in FIGS. 1 to 6, that is to say, in particular, the pivoting element 14 and the actuator 3, that pivoting element 14 which is closest to the potential collision location being pivoted, in particular, with the result that only the side bolster which is closest to the collision location is deformed.

1. A vehicle seat arrangement for a motor vehicle,
comprising
a vehicle seat;
a pre-crash control unit which generates a control signal in the case of an impending collision of the motor vehicle;
at least one pivoting element which is arranged in or on a backrest of the vehicle seat in order to move a vehicle occupant who is situated on the vehicle seat, and
an actuator which, upon a control signal of the pre-crash control unit, which control signal indicates an impending collision, acts on a lever arm of the pivoting element in such a way that the latter performs a pivoting movement which leads to at least one region of the torso of the vehicle occupant being moved away from a possible collision region of the vehicle, wherein the actuator acts on a first lever arm of the pivoting element in such a way that a movement of a second lever arm of the pivoting element is produced, which movement generates the movement of the vehicle occupant.

2. The vehicle seat arrangement as claimed in claim 1, wherein the pivoting element is configured and arranged in such a way that the pivoting movement leads to at least the region of the torso of the vehicle occupant performing a movement in the vehicle transverse direction.

3. (canceled)

4. The vehicle seat arrangement as claimed in claim 1, wherein the pivoting element is arranged in such a way that, during the performance of the pivoting movement, it acts on a thoracic region and/or shoulder region of the vehicle occupant.

5. The vehicle seat arrangement as claimed in claim 1, wherein the pivoting element is arranged at least in sections in or on a lateral region of the vehicle seat.

6. The vehicle seat arrangement as claimed in claim 1, comprising two pivoting elements which are arranged at least in sections in or on lateral regions of the vehicle seat which lie opposite one another, the pivoting elements in each case being assigned an actuator for acting on the pivoting element, and the pre-crash control unit being configured to transmit a control signal only to one of the two actuators in the case of an impending collision of the vehicle.

7. The vehicle seat arrangement as claimed in claim 1, wherein the actuator is arranged at least partially in or on the backrest of the vehicle seat.

8. The vehicle seat arrangement as claimed in claim 1, wherein the actuator is configured to exert a pressing force on the pivoting element.

9. The vehicle seat arrangement as claimed in claim 1, wherein the actuator is configured to exert a pulling force on the pivoting element.

10. The vehicle seat arrangement as claimed in claim 1, wherein the actuator comprises an inflatable element which is inflated as a reaction to the control signal and acts on the pivoting element.

11. The vehicle seat arrangement as claimed in claim 9, further comprising a supporting element, on which the inflatable element is supported.

12. The vehicle seat arrangement as claimed in claim 1, wherein the actuator comprises an elastic element which acts on the pivoting element as a reaction to the control signal.

13. The vehicle seat arrangement as claimed in claim 1, wherein the actuator comprises a movable element which acts on the pivoting element as a reaction to the control signal.

14. The vehicle seat arrangement as claimed in claim 12, wherein the movable element is of linearly movable configuration.

15. The vehicle seat arrangement as claimed in claim 12, wherein the movable element is arranged such that it can be moved in the manner of a piston in or on a guide.

16. The vehicle seat arrangement as claimed in claim 1, wherein at least one of the pivoting element and the actuator is configured and arranged in such a way that it absorbs energy by way of at least one of elastic deformation and plastic deformation in the case of a collision of the vehicle.

17. A method for operating a vehicle seat arrangement for a motor vehicle having the steps:
providing of a vehicle seat and at least one pivoting element which is arranged in or on a backrest of the vehicle seat; and
generating of a control signal which indicates an impending collision of the motor vehicle;
wherein upon the control signal, a lever arm of the pivoting element is acted on in such a way that said pivoting element performs a pivoting movement which leads to at least one region of the torso of the vehicle occupant being moved away from a possible collision region of the vehicle, wherein an actuator acts on a first lever arm of the pivoting element in such a way that a movement of a second lever arm of the pivoting element is produced, which movement generates the movement of the vehicle occupant.
